(19) United States
(12) Patent Application Publication
(10) Pub. No.: US 2005/0251273 A1
(43) Pub. Date: Nov. 10, 2005

(54) Dynamic audio control circuit and method

(75) Inventors: Michael W. Bychowsky, Crystal Lake, IL (US); David P. Peterson, Grayslake, IL (US); Ryan E. Seick, Cary, IL (US)

Correspondence Address: VEDDER PRICE KAUFMAN & KAMMHOLZ, 222 N. LASALLE STREET, CHICAGO, IL, 60601, US

(73) Assignee: Motorola, Inc., Schaumburg, IL (US)

(21) Appl. No.: 10/839,657

(22) Filed: May 5, 2004

(51) Int. Cl. G06F 17/00

(52) U.S. Cl. 700/94; 381/56

(57) ABSTRACT

A dynamic audio control circuit (10) and method receives audio type information (70) or audio information (670) embedded in an audio signal (72, 672) and in response dynamically adjusts the audio signal (72, 672) without user intervention. The dynamic audio control circuit (10) may adjust equalization and time delay parameters based on, for example, an audio spectrum analysis of the received audio information (670) embedded in the audio signal (672). According to one embodiment, the audio type information (70) may be, for example, descriptive information such as station and program information transmitted along with a standard radio, television or satellite broadcast. According to another embodiment, the audio type information (70) may be equalization and time delay settings associated with the audio signal (72). The audio characterization information (74, 674) may be used to characterize the audio signal (72, 672) in order to provide a basis for adjusting or customizing the audio signal (72, 672) to the taste of the user.

### FIELD OF THE INVENTION

The invention relates generally to audio systems and, more particularly, to audio customization circuits and methods.

### BACKGROUND OF THE INVENTION

Audio equalizers provide for the separate manual adjustment of the relative emphasis of multiple frequency subbands of a selected audio signal so that the audio frequency response of an audio system can be operator-adjusted to suit the operator's personal preference. These audio equalizers implement different signal equalizations for different audio signal program selections by selectively coupling equalization circuits into a selected audio signal path in accordance with a selected audio program signal. For example, a radio with an audio equalizer can be utilized to provide a desired audio frequency equalization for its audio input. As a user selects a signal source such as, for example, either AM, FM or tape player modes of operation, the signal could be equalized based on the selection of the AM, FM or tape player modes. Accordingly, if an AM radio mode of operation is selected, a first fixed equalization circuit, such as a 10 kilohertz whistle notch filter, is switched into the audio signal path, whereas, if a record player mode of operation is selected, a second equalization circuit, such as a low frequency rumble filter, is switched into the audio signal path.

However, if the audio program, such as a song, changes within the selected mode, then the equalization settings of the various frequency subbands do not automatically change. For example, if, while listening to a tape of a disco song, one particular equalization setting is desired, then the equalizer does not automatically nor dynamically adjust or change the frequency equalization subbands if the tape plays a different category of music, such as classical music. As a result, the audio equalizer provides the same audio equalization for any audio signal, regardless of any change in the audio program. Therefore, these types of signal equalization selector devices only involve the use of fixed equalization networks, thus depriving the operator of the audio device the ability to dynamically change the amount of equalization to his or her own personal taste for each of the different types of audio program signals that may be selected. Consequently, the equalization of the audio frequency subbands requires manual adjustment for each selected radio or tape mode.

### BRIEF DESCRIPTION OF THE DRAWINGS

The present invention is illustrated, by way of example and not limitation, in the accompanying figures, in which like reference numerals indicate similar elements, and in which:

FIG. 1 is a block diagram illustrating one example of a dynamic audio control circuit according to one embodiment of the invention;

FIG. 2 is a block diagram illustrating another example of the dynamic audio control circuit according to one embodiment of the invention;

FIG. 3 is a flowchart illustrating one example of a method for customizing an audio signal according to one embodiment of the invention;

FIG. 4 is a block diagram illustrating another example of the dynamic audio control circuit according to another embodiment of the invention;

FIG. 5 is a block diagram of an in-vehicle audio system according to one exemplary embodiment of the invention; and

FIG. 6 is a block diagram illustrating another example of the dynamic audio control circuit according to another embodiment of the invention.

### DETAILED DESCRIPTION OF THE PREFERRED EMBODIMENTS

A dynamic audio control circuit and method receives audio type information or audio information embedded in an audio signal and in response dynamically adjusts the audio signal without user intervention. The dynamic audio control circuit may adjust equalization and time delay parameters based on, for example, an audio spectrum analysis of the received audio information such as music or any other suitable audio program embedded in the audio signal. According to one embodiment, the audio type information may be, for example, descriptive information such as station and program information transmitted along with a standard radio, television or satellite broadcast. According to another embodiment, the audio type information may be equalization and time delay settings associated with the audio signal.

Among other advantages, the dynamic audio control circuit adapts to the varying audio information or varying audio type information embedded in the audio signal. In response to receiving the audio type information, the dynamic audio control circuit automatically adjusts audio parameters such as spectral equalization and time delay parameters. According to one embodiment, the dynamic audio control circuit automatically detects the audio type information and the audio information embedded in the audio signal, whether it is a type of music, data representing or describing the type of music (or program) or the actual equalization and time delay audio settings associated with the audio signal. As a result, the dynamic audio control circuit automatically adjusts the audio signal parameter settings associated with the audio signal without user intervention according to the audio type information and the audio information embedded in the audio signal.

The dynamic audio control circuit may also automatically change the audio signal parameter settings in real time during, for example, a song or a news broadcast if a change in the audio type information or the audio information is detected. According to one embodiment, if a song has a soft passage, then the audio parameter settings may be automatically adjusted to increase an amplitude associated with the appropriate frequency spectral bands. Alternatively, if a loud passage of a song is played, then the audio parameters may be automatically altered to reduce the amplitude of the audio signal and further alter the frequency spectrum bands appropriately. As a result, the audio parameters of the audio signal may be adjusted according to tens, hundreds, thousands or more different settings automatically, and dynamically in real time in response to a detected change in the audio type information and without user intervention. Therefore, the playback of the audio signal may be customized automatically while using far more audio parameter settings than previously available. Consequently, the dynamic audio control circuit and method automatically and without user intervention adapts to the varying audio type information and audio information transmitted in the audio signal rather than by detecting a fixed mode selection or a preprogrammed preset.

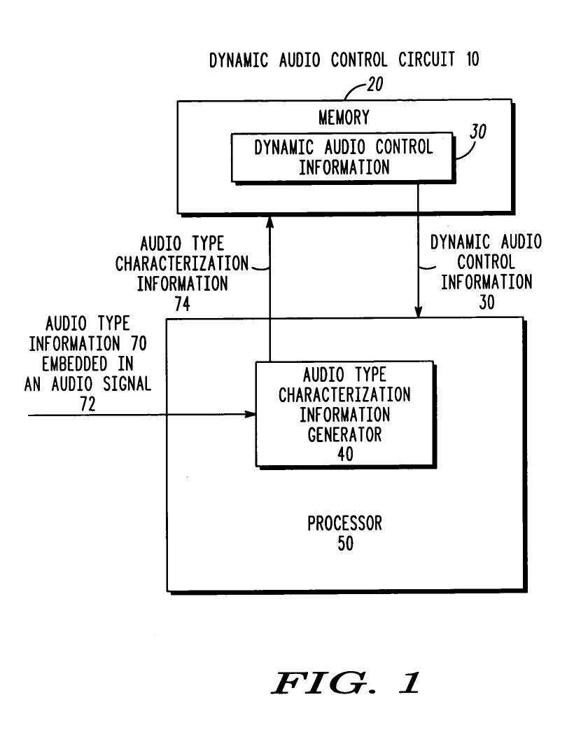

FIG. 1 is a block diagram of a dynamic audio control circuit 10 including memory 20 and a processor 50 according to one embodiment of the present invention. The memory 20 may be, for example, random access memory (RAM), read-only memory (ROM), optical memory or any other suitable storage medium located locally or remotely such as via a server. Additionally, the memory may be accessible by a wireless wide area network (WWAN), a wide access network (WAN), a local area network (LAN), a wireless local area network (WLAN), an IEEE 802.11 wireless network, a Bluetooth network or any suitable communication interface or network. Memory 20 includes dynamic audio control information 30. As will be discussed further below, the dynamic audio control information 30 controls various parameters of the audio signal 72 such as, for example, spectral equalization and time delay settings.

The processor 50 may be one or more suitably programmed processors, such as a microprocessor, a microcontroller or a digital signal processor and, therefore, includes associated memory, such as memory 20, that contains executed instructions that, when executed, cause the processor 50 to carry out the operations described herein. In addition, the processor 50, as used herein, includes discrete logic, state machines or any other suitable combination of hardware, software and/or firmware. The processor 50 further includes an audio characterization information generator 40. According to the embodiment shown in FIG. 1, the audio characterization information generator 40 represents a driver or any suitable executable software program operating in the processor 50.

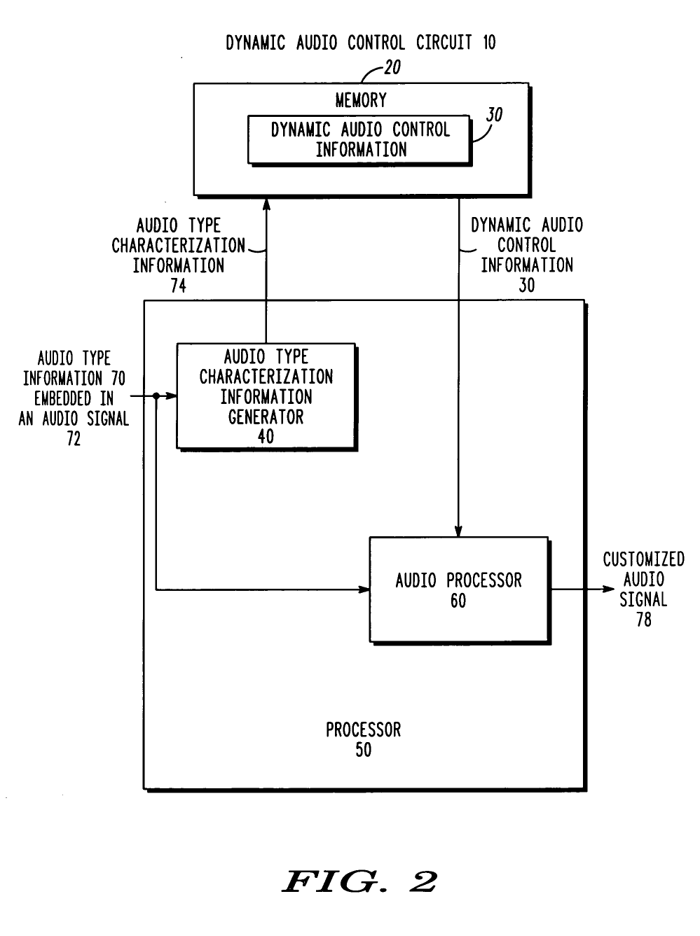

FIG. 2 is a block diagram illustrating another example of the dynamic audio control circuit 10 according to another embodiment of the invention. According to this embodiment, processor 50 further includes an audio processor 60. Audio processor 60, according to one embodiment, represents a suitable executable software program or driver operating on the processor 50, such as a digital signal processor. In addition, the audio processor 60 includes analog or digital hardware, discrete logic, state machines or any other suitable combination of hardware, software and/or firmware.

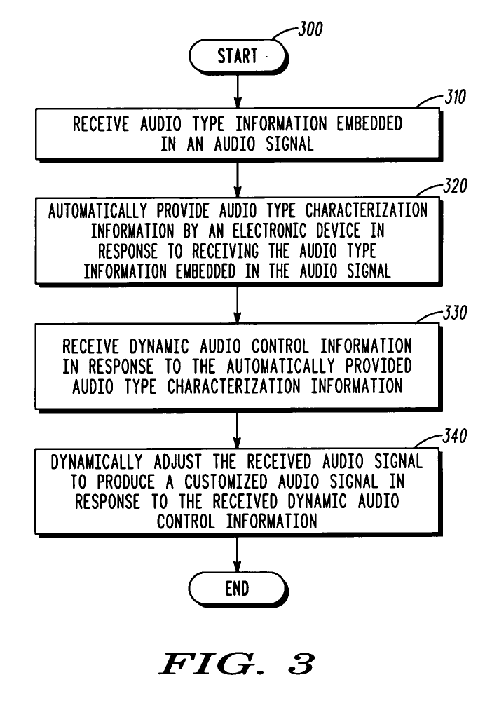

FIG. 3 illustrates a method for customizing an audio signal according to one embodiment of the invention. The method shown in FIG. 3 may be carried out by the audio characterization information generator 40 and the audio processor 60 with respect to FIG. 1 and FIG. 2 according to one embodiment of the invention. However, any other suitable structure may also be used. It will be recognized that the method shown in FIG. 3, beginning with step 300, will be described as a series of operations, but the operations may be performed in any suitable order and may be repeated in any suitable combination.

As shown in step 310, the audio type characterization information generator 40 receives audio type information 70 embedded in an audio signal 72. The audio signal 72 may be an analog signal or digital data. For example, the audio signal 72 may be received from a playback circuit, such as a receiver, so that the audio signal 72 is an analog signal. Alternatively, an analog-to-digital converter coupled to the playback circuit may convert the audio signal 72 from an analog format to digital audio data. According to yet another embodiment, the receiver, as is known in the art, may provide the audio signal 72 as digital data directly to the audio type characterization information generator 40 and the audio processor 60.

According to one embodiment, the audio type information 70 embedded in the audio signal 72 may be associated with a terrestrial radio broadcast, a satellite radio broadcast or a television audio broadcast. For example, the terrestrial radio broadcast may include RDS (Radio Data System) data. RDS data includes station information, the title of a song, an artist's name, and is typically broadcast along with a standard FM radio broadcast. Additionally, a satellite radio broadcast, such as, for example, an XM satellite radio broadcast, includes program information that similarly broadcasts, among other things, station information, the title of a song along with the artist's name.

Information relating to the content of an MP3 file, a CD or a DVD, for example, is known to be embedded in the received audio signal 72 and therefore may be associated with the audio type information 70 embedded in the audio signal 72. For example, the audio type information 70 embedded in the audio signal 72 may include a song title, a program title, a commercial, a station identification, a station music category, a music genre, censor artist information and or any suitable type of information. The censor information may include, for example, a rating of the type of music or audio being broadcast or played back. For example, the Entertainment Software Ratings Board (ESRB) typically rates the content of music or audio according to several ratings categories. The ESRB ratings include, for example, early childhood, everyone, teen, mature, adults only and rating pending.

According to one embodiment, the audio type information 70 embedded in the audio signal 72 may include spectral equalization, bandwidth, time delay, surround sound channel, stereo channel, amplitude or any other suitable type of information. For example, a broadcast system may embed within the audio signal 72 the actual desired spectral equalization, bandwidth, time delay, surround sound channel, stereo channel and amplitude information suitable for playback adjustment of the audio signal 72. According to one such embodiment, the audio type information 70 may conform to a standard data format and protocol either currently established or developed in the future in order to allow broadcast transmitters to transmit and receivers and playback devices to receive and properly interpret the audio type information 70. For example, the audio type information 70 may be embedded in an existing data transmission protocol, such as an MP3 file, a CD, a DVD protocol, the RDS radio broadcast protocol and the XM satellite radio broadcast protocol, or any other suitable protocol currently established or developed in the future.

As shown in step 320, the audio characterization information generator 40 automatically provides audio type characterization information 74 to the memory 20 in response to receiving the audio type information 70 embedded in the audio signal 72. According to one embodiment, the audio type information 70 is radio broadcast data providing descriptor information related to the music or other type of programming that is currently being broadcast. According to this embodiment, the audio type characterization information 74 may then represent the broadcast data providing the descriptor information. Other embodiments and other examples will be discussed further below.

As shown in step 330, the audio characterization information generator 40 receives dynamic audio control information 30 from the memory 20 in response to providing the audio type characterization information 74 to the memory 20. According to one embodiment, the memory 20 includes a lookup table containing an array of dynamic audio control information 30 corresponding to an array of audio type characterization information 74. Accordingly, the lookup table has an input to receive the audio type characterization information 74. Similarly, the lookup table has an output to provide the dynamic audio control information 30. For example, the memory 20 may provide the dynamic audio control information 30 in response to receiving the audio type characterization information 74 by a lookup table.

According to one embodiment, the user may program the dynamic audio control information 30 in the lookup table such that when specific audio type characterization information 74 is received, the lookup table in memory 20 provides the corresponding desired dynamic audio control information 30. For example, the dynamic audio control information 30 may include any suitable type of information to control a parameter of the audio signal 72, such as spectral equalization, bandwidth, time delay, surround sound channel, stereo channel and amplitude information. Alternatively, the audio characterization information generator 40 and the memory 20 may be programmed with a polynomial or other suitable equation for converting the audio type characterization information 74 into dynamic audio control information 30 in either a continuous or discrete manner.

The dynamic audio control information 30 may include information such as surround sound settings in order to adjust or customize the audio signal 72. For example, the audio processor may be controlled to provide mono playback, stereo playback, three channel playback, four channel playback, 5.1 channel playback, 6.1 channel playback, 7.1 channel playback, 8.1 channel playback, 9.1 channel playback or any other suitable type of surround sound playback available presently or in the future. According to another embodiment, the user may program the lookup table in memory 20 so that a song or the audio portion of a movie or television program broadcasting in, for example, 5.1 channel surround sound mode will result in dynamic audio control information 30, to effect stereo playback in the audio processor 60. In other words, the user may actually prefer stereo sound rather than surround sound for a particular audio program.

Alternatively, the lookup table in the memory 20 may, in response to detecting, for example, a stereo signal as part of the audio type characterization information 74, provide surround sound channel information as dynamic audio control information 30 to the audio processor 60 for playback of the stereo audio signal 72 as a surround sound signal. As is currently known, surround sound information may include, for example, equalizer settings, time delay settings and volume or amplitude level settings.

As shown in step 340, the audio processor 60 dynamically adjusts the received audio signal 72 to produce a customized audio signal 78 in response to the received dynamic audio control information 30. The dynamic control information 30 produced by memory 20 may include, for example, spectral equalization data, time delay data, surround sound channel data, stereo channel data, amplitude data and censor data to control the audio processor 60.

According to one embodiment, a user may program the lookup table within the memory 20 so that if a particular level of censor information is reached, the dynamic audio control information 30 may, for example, cause the audio processor 60 to “bleep out” a censored portion of the audio signal 72 or otherwise overlay another audio signal on to the audio signal 72. Other examples of editing based on such censorship may including cutting out a portion of the audio signal 72 or notching out the audio signal 72 in either the time or frequency domain by either amplitude attenuation or notching out a portion of the frequency spectrum. Alternatively, censoring the audio signal 72 may include attenuating the audio signal 72 and replacing the censored portion of the audio signal 72. For example, the dynamic audio control information 30 may cause the audio processor 60 to overlay or replace a portion of the censored audio signal 72 with other lyrics or an alternative spoken word, lyrics or a tone, white noise or any other suitable signal. For example, the audio processor 60 may include a preprogrammed playback circuit or a tone generator for use in overlaying or deleting offensive language.

According to one embodiment, the audio type characterization information 74 is associated with audio customization settings that are different from audio customization settings associated with the dynamic audio control information 30. As a result, although a particular set of audio customization settings such as a spectral equalization and a time delay may be specified by the producer of the programming such as the music or other suitable audio broadcast, the user may program the memory 20 so that in response to receiving the audio customization settings identified in the audio type information 70, the memory 20 produces different audio customization settings as produced in the dynamic audio control information 30.

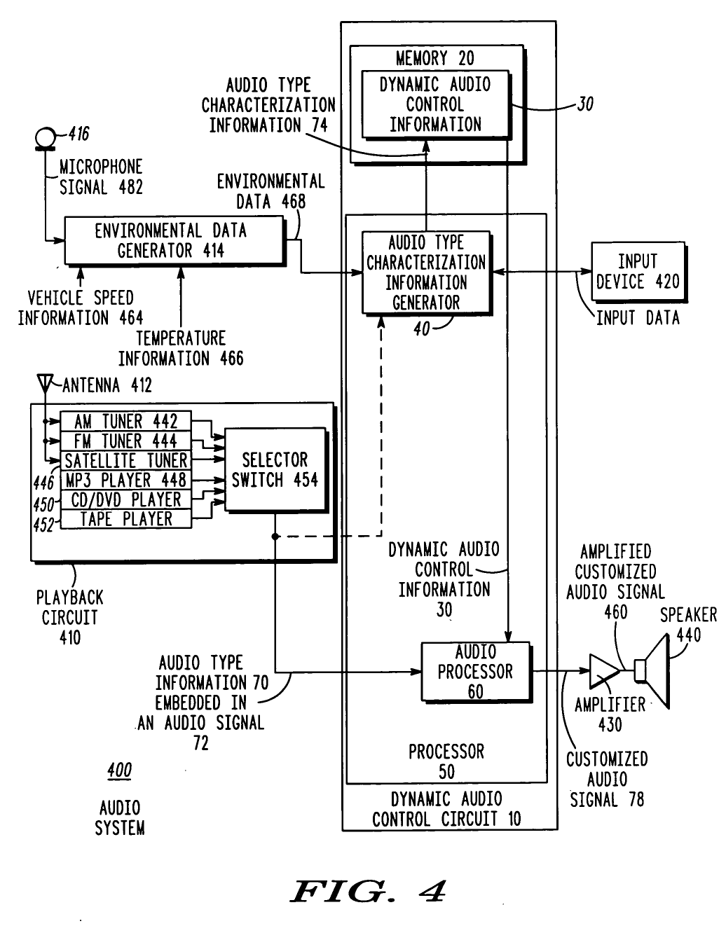

FIG. 4 illustrates an audio system 400 including the dynamic audio control circuit 10, a playback circuit 410, an antenna 412, an environmental data generator 414, a microphone 416, an input device 420, an amplifier 430 and a speaker 440. The playback circuit 410 further includes an AM tuner receiver 442, an FM tuner receiver 444, a satellite tuner receiver 446, an MP3 player 448, a CD/DVD player 450, a tape player 452, or any other suitable playback device, and a selector switch 454. The playback circuit 410 is operative to provide the audio type information 70 embedded in the audio signal 72 to the audio processor 60 and to the audio characterization information generator 40.

The amplifier 430 may represent one or more amplifiers and is coupled to the audio processor 60. The amplifier 430 receives the customized audio signal 78 and in response produces an amplified customized audio signal 460.

The environmental data generator 414 receives a microphone signal 462 (from the microphone 416), vehicle speed information 464 and temperature information 466. The vehicle speed information 464 and temperature information 466 may be provided by a vehicle computer as is known in the art. Accordingly, the audio characterization information generator 40 home or audio receiver/processor receives information regarding the environment in which the user is listening, such as the ambient noise level, the level of echo inherently produced within the room, vehicle interior or listening area, the distance between the speakers, the movement of occupants and other objects such as luggage or furniture and the amount of echo required for compensation. In response to receiving the environmental data 468, the audio characterization information generator 40 may alter the audio customization settings established in the dynamic audio control information 30 based on the ambient noise level detected by the microphone signal 462 and the environmental data 468 or the vehicle speed information 464 provided by the vehicle computer. For example, in response to receiving the environmental data 468, the audio characterization information generator 40 may produce the audio type characterization information 74 indicating that the ambient noise level has increased, and, accordingly, the audio type characterization information generator and the memory 20 may produce the dynamic audio control information 30 such that the associated audio customization settings increase the amplitude of the customized audio signals 78 in order to compensate for the increase in ambient noise.

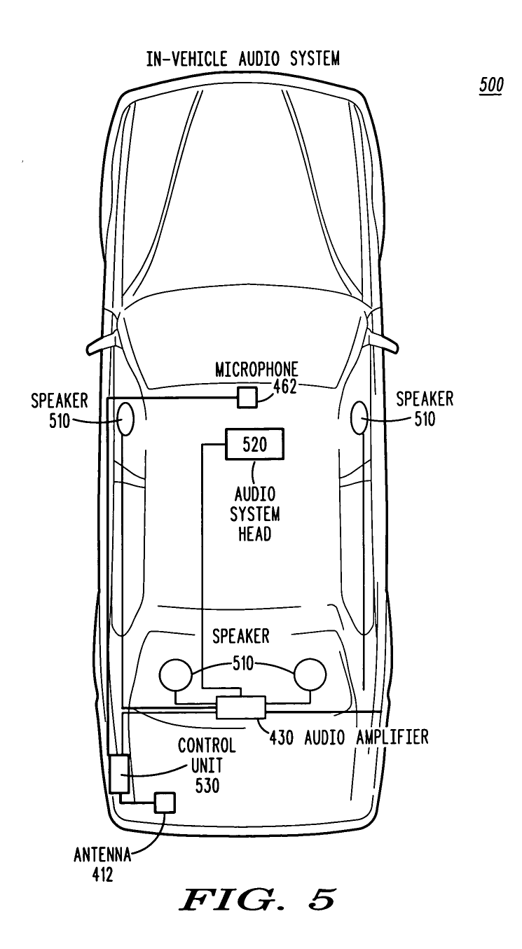

FIG. 5 illustrates an in-vehicle audio system 500. For example, the in-vehicle audio system 500 includes the components of the audio system 400 described with respect to FIG. 4 as well as speakers 510, an audio system head 520, an audio amplifier 430, an antenna 412 and a control unit 530. The vehicle may be any suitable vehicle, such as an automobile (shown in FIG. 5), truck, boat or airplane. According to one embodiment, the in-vehicle audio system 500 may be integrated with a communication apparatus, such as a wireless device, via the control unit 530 or any other suitable device.

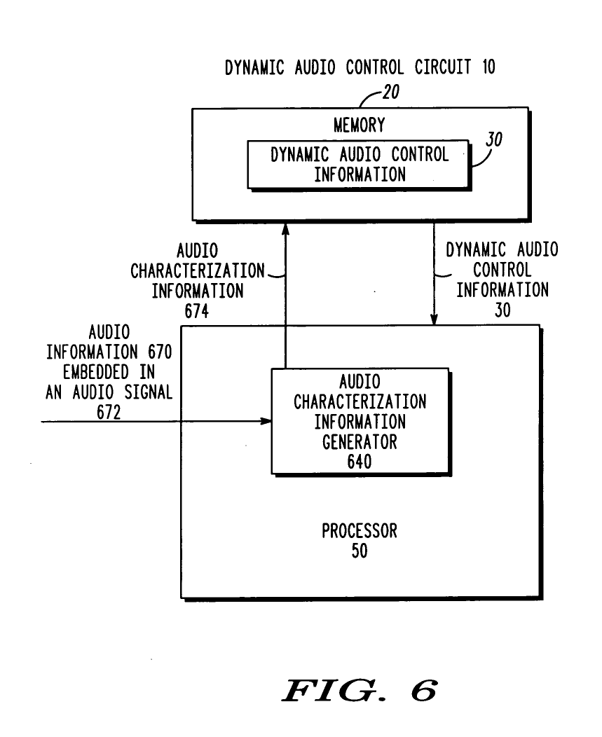

FIG. 6 is a block diagram illustrating another example of the dynamic audio control circuit 10 according to yet another embodiment of the invention. According to this embodiment, the processor 50 includes an audio characterization information generator 640. The audio characterization information generator 640 receives audio information 670 such as music or voice information embedded in an audio signal 672. According to one embodiment, the audio characterization information generator 640 automatically provides audio characterization information 674 based on an audio spectral analysis of the received audio information 670 embedded in the audio signal 672. For example, the audio characterization information generator 640 automatically provides the audio characterization information 674 based on the audio spectral analysis of the received audio information 670 embedded in the audio signal 672 when, as a result of the audio spectral analysis, the audio information 670 embedded in the audio signal 672 corresponds with a predetermined type of music or other type of audio program. For example, the audio information 670 embedded in the audio signal 672 may be music such as disco, rap, classical, waltz, blues, jazz, orchestra, opera, reggae, rock, hard rock, heavy metal or salsa. Additionally, the audio information may be associated with a type of musical instrument, such as acoustic guitar, electric guitar, piano, saxophone or any suitable type of musical instrument. Further, the audio information 670 may be associated with the environment in which the audio signal 72 is played, such as a stadium, church or hall. Furthermore, the audio type information 70 may be associated with male singing, female singing, a male voice, a female voice, a foreign language or some combination of these. The memory 20 provides the dynamic audio control information 30 in response to receiving the audio characterization information 674 as previously discussed.

Among other advantages, the dynamic audio control circuit 10 adapts to the varying audio type information 70 and audio information 670 embedded in the audio signal 72, 672, and in response automatically adjusts audio parameters such as spectrum equalization and time delay parameters. According to one embodiment, the dynamic audio control circuit 10 automatically detects the audio type information 70 and the audio information 670 embedded in the audio signal 72, 672 whether it is a type of music, data representing the type of music (or program) or the actual equalization and time delay audio settings associated with the audio signal 72, 672. As a result, the dynamic audio control circuit 10 automatically adjusts the audio signal parameter settings associated with the audio signal 72, 672 without user intervention according to the audio type information 70 and the audio information 670 embedded in the audio signal 72, 672.

The dynamic audio control circuit 10 may automatically change the audio signal parameter settings in real time during, for example, a song or a news broadcast if a change in the audio type information 70 or the audio information 670 is detected. According to one embodiment, if a song has a soft passage, then the audio parameter settings may be automatically adjusted to increase an amplitude associated with the appropriate frequency spectrum bands. Alternatively, if a loud passage of a song is played, then the audio parameters may be automatically altered to reduce the amplitude of the audio signal 72, 672 and further alter the frequency spectrum bands appropriately. As a result, the audio parameters of the audio signal 72, 672 may be adjusted according to tens, hundreds, thousands or more different settings automatically, without user intervention, and dynamically in real time and in response to a detected change in the audio type information 70 or audio information 670. Therefore, the playback of the audio signal 72, 672 may be customized automatically while using far more audio parameter settings than previously available. Consequently, the dynamic audio control circuit 10 and method automatically, and without user intervention, adapts to the varying audio type information 70 and audio information 670 transmitted in the audio signal 72, 672 rather than by a fixed station or a preprogrammed preset.

It is understood that the implementation of other variations and modifications of the present invention and its various aspects will be apparent to those of ordinary skill in the art and that the invention is not limited by the specific embodiments described. It is therefore contemplated to cover by the present invention any and all modifications, variations or equivalents that fall within the spirit and scope of the basic underlying principles disclosed and claimed herein.

1. A method for customizing an audio signal comprising:
receiving audio type information embedded in an audio signal;
automatically providing audio type characterization information by an electronic device in response to receiving the audio type information embedded in the audio signal; and
receiving dynamic audio control information in response to automatically providing the audio type characterization information.

2. The method of claim 1 wherein the audio type information embedded in the audio signal is associated with at least one of: terrestrial radio broadcast, satellite radio broadcast, MP3 descriptor, CD descriptor, television audio broadcast and MPEG descriptor information.

3. The method of claim 2 wherein the audio type information embedded in the audio signal includes at least one of: song title, program title, commercial title, station identification, station music category, genre, censor and artist information.

4. The method of claim 1 wherein the received dynamic audio control information includes at least one of: spectral equalization, time delay, surround sound channel, stereo channel, amplitude and censor information.

5. The method of claim 1 wherein the received audio type information, the provided audio type characterization information and the received dynamic audio control information are associated with at least one of: spectral equalization, bandwidth, time delay, surround sound channel, stereo channel and amplitude information.

6. The method of claim 5 wherein the audio type characterization information is associated with audio parameter settings that are different from audio parameter settings associated with the dynamic audio control information.

7. A method for customizing audio data comprising:
receiving audio type information embedded in an audio signal;
automatically providing audio type characterization information by an electronic device in response to receiving the audio type information embedded in the audio signal;
receiving dynamic audio control information in response to automatically providing the audio type characterization information; and
dynamically adjusting the received audio signal to produce a customized audio signal in response to the received dynamic audio customization data.

8. The method of claim 7 wherein the received dynamic audio control information includes at least one of: spectral equalization, bandwidth, time delay, surround sound channel, stereo channel, amplitude and censor information.

9. A circuit operative to customize an audio signal, comprising:
memory, containing dynamic audio control information;
an audio type characterization information generator, operatively coupled to the memory, and operative to:
receive audio type information embedded in an audio signal;
automatically provide audio type characterization information to the memory in response to the received audio type information embedded in the audio signal; and
receive the dynamic audio control information from the memory in response to the automatically provided audio type characterization information.

10. The circuit of claim 9 wherein the audio type information embedded in the audio signal is associated with at least one of: terrestrial radio broadcast, satellite radio broadcast, MP3 descriptor, CD descriptor, television audio broadcast and MPEG descriptor information.

11. The circuit of claim 10 wherein the audio type information embedded in the audio signal includes at least one of: song title, program title, commercial title, station identification, station music category, genre, censor and artist information.

12. The circuit of claim 9 wherein the received dynamic audio control information includes at least one of: spectral equalization, time delay, surround sound channel, stereo channel, amplitude and censor information.

13. The circuit of claim 9 wherein the received audio type information, the provided audio type characterization information and the received dynamic audio control information are associated with at least one of: spectral equalization, bandwidth, time delay, surround sound channel, stereo channel and amplitude information.

14. The circuit of claim 13 wherein the audio type characterization information is associated with audio parameter settings that are different from audio parameter settings associated with the dynamic audio control information.

15. An audio system comprising:
memory, containing dynamic audio control information;
an audio type characterization information generator, operatively coupled to the memory, and operative to:
receive audio type information embedded in an audio signal;
automatically provide audio type characterization information to the memory in response to the received audio type information embedded in the audio signal;
receive the dynamic audio control information from the memory in response to the automatically provided audio type characterization information;
an audio processor, operatively coupled to the audio type characterization information generator, and operative to receive the audio signal and the dynamic audio control information and in response to dynamically adjust the audio signal to produce a customized audio signal; and
a playback circuit including at least one of: a tuner, a tape player, an MP3 player, a CD player and a DVD player, operatively coupled to the audio processor and to the audio type characterization information generator, and operative to provide the audio signal to the audio processor and to the audio type characterization information generator.

16. The audio system of claim 15 including:
at least one amplifier, operatively coupled to the audio processor, and operative to receive the customized audio signal and, in response, to produce an amplified customized audio signal.

17. The audio system of claim 16 including at least one speaker, operatively coupled to at least one amplifier, and operative to receive the amplified customized audio signal and, in response, to acoustically produce the amplified customized audio signal.

18. Memory containing instructions executable by one or more processing devices that causes the one or more processing devices to:
receive audio type information embedded in an audio signal;
automatically provide audio type characterization information by an electronic device in response to receiving the audio type information embedded in the audio signal; and
receive dynamic audio control information in response to the automatically provided audio type characterization information.

19. The memory of claim 18 wherein the received dynamic audio control information includes at least one of: spectral equalization, time delay, surround sound channel, stereo channel, amplitude and censor information.

20. A method for customizing an audio signal comprising:
receiving audio information embedded in an audio signal;
automatically providing audio characterization information by an electronic device in response to receiving the audio information embedded in the audio signal; and
receiving dynamic audio control information in response to automatically providing the audio characterization information.

21. The method of claim 20 including:
automatically providing the audio characterization information based on an audio spectral analysis of the received audio information embedded in the audio signal by the electronic device.

22. The method of claim 21 including:
automatically providing the audio characterization information based on the audio spectral analysis of the received audio information embedded in the audio signal when, as a result of the audio spectral analysis, the audio information embedded in the audio signal corresponds with at least one of: disco, rap, classical, waltz, blues, jazz, orchestra, opera, stadium, church, hall, reggae, rock, hard rock, heavy metal, salsa, instrumental, acoustic guitar, electric guitar, piano, saxophone, male singing, female singing, male voice, female voice and foreign language information.

23. A circuit operative to customize an audio signal, comprising:
memory, containing dynamic audio control information;
an audio characterization information generator, operatively coupled to the memory, and operative to:
receive audio information embedded in an audio signal;
automatically provide audio characterization information to the memory in response to the received audio information embedded in the audio signal; and
receive the dynamic audio control information from the memory in response to the automatically provided audio characterization information.

24. The circuit of claim 23 wherein the audio characterization information generator is operative to:
automatically provide the audio characterization information to the memory based on an audio spectral analysis of the received audio information embedded in the audio signal.

25. The circuit of claim 24 wherein the dynamic audio customization data generator is operative to:
automatically provide the audio characterization information based on the audio spectral analysis of the received audio information embedded in the audio signal, when, as a result of the audio spectral analysis, the audio information embedded in the audio signal corresponds with at least one of: disco, rap, classical, waltz, blues, jazz, orchestra, opera, reggae, rock, hard rock, heavy metal, salsa, instrumental, acoustic guitar, electric guitar, piano, saxophone, stadium, church, hall, male singing, female singing, male voice, female voice and foreign language information.
